(19) United States
(12) Patent Application Publication
(10) Pub. No.: US 2005/0085112 A1
(43) Pub. Date: Apr. 21, 2005

(54) Pick-up cap for electrical connector

(76) Inventors: Guozeng Zhang, Kunsan (CN); Zhefeng Wu, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/965,965

(22) Filed: Oct. 15, 2004

(30) Foreign Application Priority Data
Oct. 17, 2003 (CN) 2003201103178

(51) Int. Cl. H01R 13/44

(52) U.S. Cl. 439/135

(57) ABSTRACT

A pick-up cap (10) for an electrical connector (20) includes a top wall (11) and a pair of sidewalls (12,13) extending downwardly from the top wall. A stopping tab (14) projects from a front end of the top wall and extends perpendicularly to the top wall. Each sidewall has an inclined face (15) formed in a lower portion thereof and a protrusion (17) formed in an inner face thereof. The pick-up cap is assembled onto the electrical connector for use with a vacuum suction apparatus to facilitate automatic assembling of the electrical connectors.

### BACKGROUND OF THE INVENTION

1. Field of the Invention

The present invention generally relates to a pick-up cap, and more particularly to a pick-up cap for an electrical connector having a cylindrical shape.

2. Description of Related Art

In order to increase production efficiency of products, roboticized assembling is generally adopted during manufacturing and assembling of electronic components. For example, electrical connectors are usually picked up and placed on a circuit board by a suction nozzle of a suction apparatus to realize roboticized assembling. It becomes an issue when the electrical connector has a cylindrical figuration. Chinese Patent Issue No. CN2519463Y discloses a connector comprising a housing and a shielding shell surrounding the housing. The housing includes a cylindrical body and a platform having an assembling surface for use with a nozzle. As the platform with the assembling surface is integrally formed with the housing, a specific mold is required to accommodate the housing having such a complicated structure. Furthermore, the platform of the housing cannot be repeatedly applied during the assembling process. Therefore, this inevitably increases cost of the electrical connectors.

Hence, a pick-up cap is required to overcome the disadvantages of the related art.

### SUMMARY OF THE INVENTION

An object of the present invention is to provide a pick-up cap used in an electrical connector for facilitating automatic assembling of the electrical connector.

Another object of the present invention is to provide an electrical connector assembly with a detachable pick-up cap for cost down.

In order to achieve the objects set forth, an electrical connector assembly in accordance with the present invention comprises an electrical connector and a pick-up cap. The electrical connector comprises an insulative housing, a plurality of terminals received in the insulative housing and a shell having a cylindrical outline. The shell comprises a rear tab latched on the insulative housing and a pair of opposite grounding tabs located at a lower portion thereof. The pick-up cap can be detachable assembled to the insulative housing and comprises a top wall and a pair of sidewalls extending downwardly from opposite side edges of the top wall. Each sidewall comprises an inclined face formed at a front lower edge thereof, a protrusion on an inner face thereof and a wedged portion located below the protrusion and behind the inclined face.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a connector assembly in accordance with the present invention;

FIG. 2 is an exploded perspective view of FIG. 1;

FIG. 3 is a perspective view of a pick-up cap of the connector assembly;

FIG. 4 is a rear plan view of the connector assembly shown in FIG. 1;

FIG. 5 is a side elevational view of the electrical connector; and

FIG. 6 is a bottom view of the electrical connector.

### DETAILED DESCRIPTION OF THE INVENTION

Reference will now be made in detail to the preferred embodiment of the present invention.

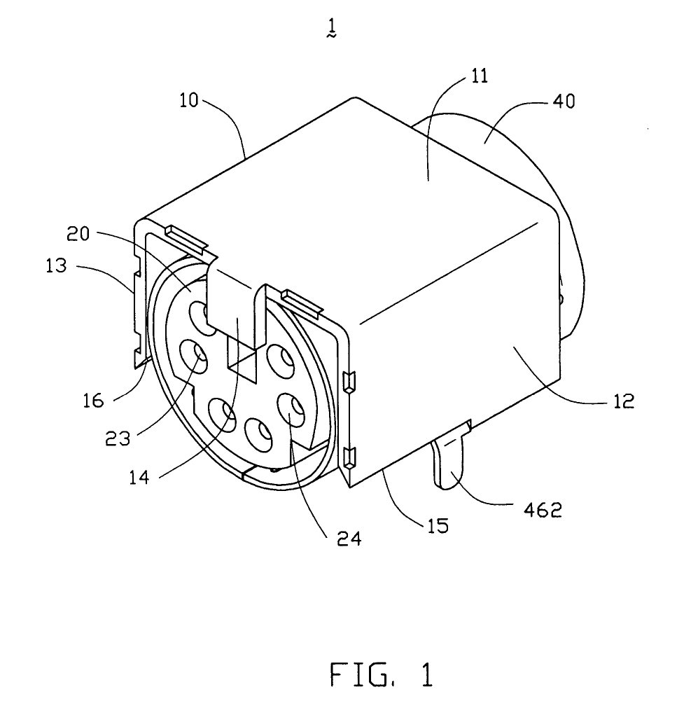

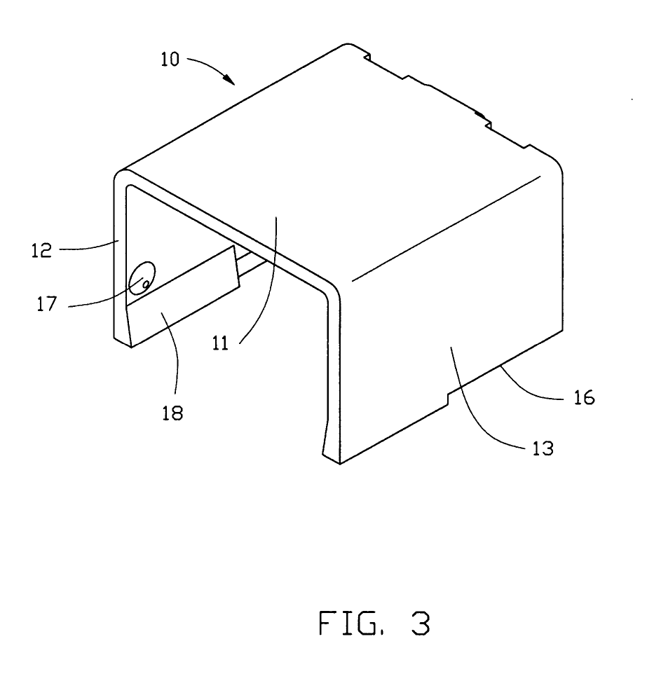

Referring to FIG. 1 to FIG. 3, an electrical connector assembly 1 in accordance with the present invention comprises an electrical connector 20 and a pick-up cap 10 assembled on the electrical connector 20.

The pick-up cap 10 is made of plastic and comprises a top wall 11 and a pair of sidewalls 12, 13 extending from side edges of the top wall 11. A stopping tab 14 perpendicularly extends downwardly from a front end of the top wall 11. Each sidewall 12, 13 comprises an inclined face 15, 16 formed at a lower edge thereof, a protrusion 17 disposed in an inner face thereof, and a wedged portion 18 located below the protrusion 17 and behind the inclined face 16.

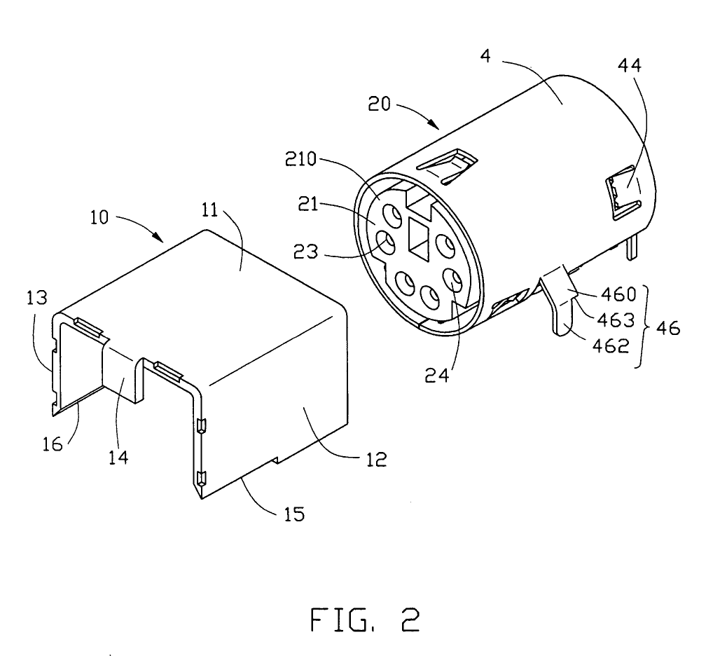

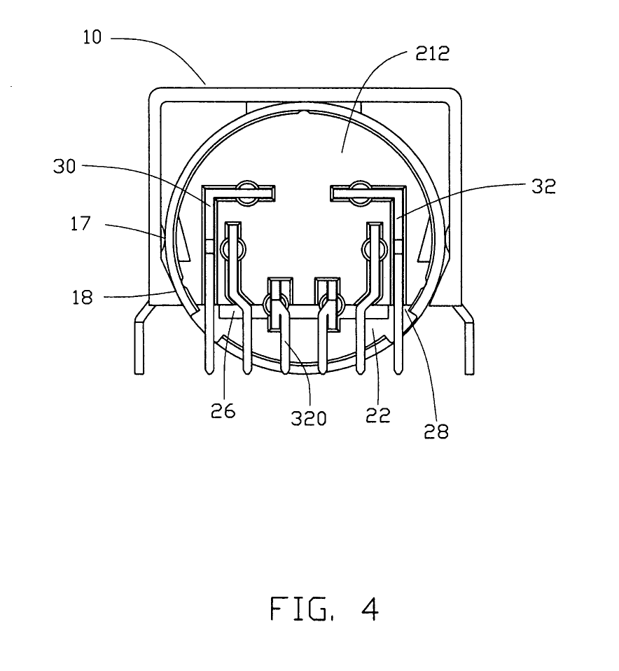

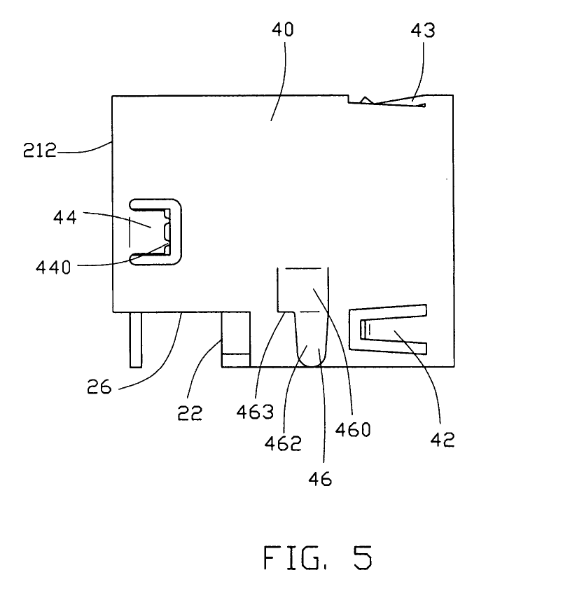

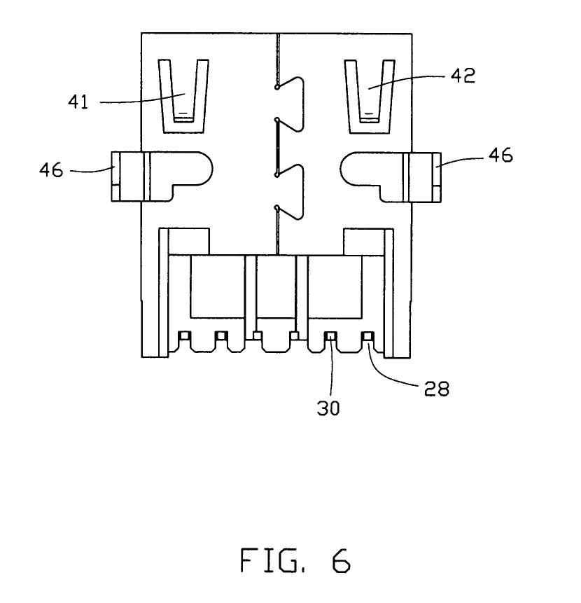

Referring to FIG. 4 to FIG. 6, the electrical connector 20 comprises an insulative housing 21, a plurality of terminals 30 received in the insulative housing 21 and a shell 40 enclosing the insulative housing 21 therein. The insulative housing 21 has a front face 210 (FIG. 2) and a rear face 212 opposite to the front face 21. A plurality of insertion holes 23 is defined in the front face 210 for providing insertion of terminals of a complementary connector (not shown). A plurality of passages 24 extend from the insertion hole 23 through the rear face 212, and each has a smaller radius than the insertion hole 23. A plurality of channels 28 are defined in the rear face 212. The insulative housing 21 is formed with a step portion 22 in a rear portion thereof and disposes a support portion 26 extending rearwardly behind the step portion 22.

Each terminal 3 comprises a contact portion (not shown) received in a corresponding passage 23, a connecting portion 32 bent downwardly from the contact portion and extending out of the insulative housing 21, and a tail portion 320 extending downwardly from the connecting portion 32 beyond the support portion 26 of the insulative housing 21 for being soldered on a printed circuit board (not shown). The connecting portions 32 are received in corresponding channels 28 of the insulative housing 21.

Referring to FIG. 2, the metallic shell 40 with a cylindrical outline comprises a top tab 43 extending rearwardly and inwardly in a top front portion thereof, a pair of rearwardly extending opposite lower tabs 41, 42 in side portions thereof, a pair of opposite rear tabs 44 formed in a rear portion thereof and a pair of opposite grounding tabs 46 located at a lower portion thereof. Each rear tab 44 is formed with a plurality of projections 440 engaging with the insulative housing 21 to provide a mechanical retention therebetween. Each grounding tab 46 comprises an upper portion 460 extending outwardly and downwardly from the lower front portion of the shell 40, a lower portion 462 extending downwardly from the upper portion 460 and a step portion 463 formed therebetween. When the electrical connector 20 is mounted on the printed circuit board, the electrical connector 20 is supported on the printed circuit board, by the support portion 26 of the insulative housing and the step portion 463 of the grounding tab 46 of the shell 40.

In assembly, the top wall 11 contacts with the top of the shell 40 by a downward force exerted thereon. The pair of protrusions 17 of the pick-up cap 3 resiliently engage with the rear tabs 44 of the shell 40. The stopping tab 14 connects with the front face 210 of the insulative housing 21. The wedged portions 18 substantially attach to the lower portion of the shell 40. The inclined faces 15, 16 fittingly mount on the upper portions 460 of the grounding tab 46 under a stable and self-adjusting manner. Thus, the pick-up cap 10 is fixed on the electrical connector 20 securely and has self-adjusting function. A vacuum suction apparatus (not shown) seizes the pick-up cap 10 of the electrical connector assembly 1, and then places the electrical connector assembly 1 onto the printed circuit board, thereby realizing automatic assembling and increasing production efficiency. Additionally, the pick-up cap is simple in structure and easy to be assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A pick-up cap for use with an electrical connector having a housing and a cylindrical outer shell enclosing the housing, comprising:
a top wall; and
a pair of sidewalls extending downwardly from side edges of the top wall, each sidewall comprising an inclined face formed on a lower edge thereof, a protrusion on an inner face thereof and a wedged portion located below the protrusion.

2. The pick-up cap as claimed in claim 1, further comprising a stopping tab perpendicularly extending from a front end of the top wall.

3. An electrical connector assembly mountable on a printed circuit board, comprising:
an electrical connector comprising:
an insulative housing;
a plurality of terminals received in the insulative housing; and
a cylindrical shell enclosing the insulative housing and comprising a rear tab bent inwardly and latched on the insulative housing, and a pair of opposite grounding tabs extending downwardly from a lower portion thereof; and
a pick-up cap removably assembled to the insulative housing, the pick-up cap comprising a top wall and a pair of sidewalls extending downwardly from side edges of the top wall, each sidewall comprising a protrusion formed on an inner face thereof for engaging with the rear tab and a wedged portion located below the protrusion and substantially attached to the shell.

4. The electrical connector assembly as claimed in claim 3, wherein the pick-up cap has a stopping tab perpendicularly extending from a front end of the top wall.

5. The electrical connector assembly as claimed in claim 4, wherein each sidewall of the pick-up cap has an inclined face formed at a front lower edge thereof for bearing against the grounding tab of the shell.

6. The electrical connector assembly as claimed in claim 5, wherein the grounding tab has an upper portion extending outwardly and downwardly from the shell for attaching to the inclined face of the pick-up cap.

7. The electrical connector assembly as claimed in claim 4, wherein the wedge portion further includes an inclined face at a lower edge thereof to fitting mount on the corresponding grounding tab under a stable and self-adjusting manner.

8. An electrical connector assembly comprising:
an electrical connector including:
an insulative housing;
a plurality of contacts disposed in the housing;
a cylindrical shield enclosing said housing in a horizontal direction; and
a pick-up cap defining a generally U-shaped structure including a top wall and two side walls and upside down attached to the shield; wherein
each of said side wall is equipped with grasping device retainably upwardly engaged with a lower portion of a columnar surface of said shield so as to be associated with the connector in a surface mounting procedure.

9. The electrical connector assembly as claimed in claim 8, wherein the uppermost point of an upper portion of the columnar surface of the shield abuts against the top wall.

10. The electrical connector assembly as claimed in claim 9, wherein said cap and said connector commonly result in a triangular type retention therebetween from a front view of said connector assembly.

11. The electrical connector assembly as claimed in claim 8, wherein the side wall is equipped with a wedge-like structure, from said front view, around the grasping device for compliance with a configuration of said columnar surface.

12. The electrical connector assembly as claimed in claim 8, wherein there is a wedge-like space, from said front view, between the cap and the shield around a corner between the top wall and the corresponding side wall due to confrontation between a right angle structure of said cap and the columnar surface of said shield.
